(19) United States
(12) Patent Application Publication
(10) Pub. No.: US 2025/0124579 A1
(43) Pub. Date: Apr. 17, 2025

(54) OBSCURED OBJECT RECOGNITION ASSOCIATED WITH CAPTURE AREA

(71) Applicant: BrightAI Corporation, San Francsico, CA (US)

(72) Inventors: Robert PARKER, Hillsborough, CA (US); Haidong WANG, Clyde Hill, WA (US); Min YANG, Redwood City, CA (US); Barry Christian ANDERSEN, Brooklyn Park, MN (US); Albert Stephen CARR, III, Merritt Island, FL (US); Samuel Roger CARLTON, Ostego, MN (US); Kevin Michael SPINAR, Shoreview, MN (US); Kevin VANDEN BERGE, Hudsonville, MI (US)

(21) Appl. No.: 18/917,454

(22) Filed: Oct. 16, 2024

Related U.S. Application Data
(60) Provisional application No. 63/591,034, filed on Oct. 17, 2023.

(51) Int. Cl. G06T 7/194; G06V 10/82

(52) U.S. Cl. CPC G06T 7/194; G06V 10/82

(57) ABSTRACT

An image may be received from a sensor associated with a capture area. Background elements associated with the capture area may be removed and a cleaned image generated. Objects may then be detected in this cleaned image. A spatial partition model may be generated to understand z-index and partially obscured areas while preserving relative object sizes. This model may be used to determine and remove foreground elements that may obstruct objects of interest. Object detection may be performed again on the further cleaned image. Detected objects may be filtered based on predefined criteria for different object classes.

### CROSS-REFERENCE TO RELATED APPLICATION

This application claims the benefit of U.S. Provisional Patent Application No. 63/591,034, filed on Oct. 17, 2023, entitled “Connected Fly Light,” the contents of which are hereby incorporated by reference herein.

### TECHNICAL FIELD

The technical field generally relates to machine learning and more specifically relates to detection of object in a capture area.

### BACKGROUND

Cameras or other sensors may capture a designated capture area. In an example, a camera may capture an area associated with a capture apparatus, such as a pest-control capture apparatus. Industries may utilize pest-control capture apparatuses, such as fly lights, glue traps, live animal traps, snap traps, electric insect zappers, or pheromone traps.

Fly lights may be used to capture flies and monitor insect populations in a given space. These fly lights may lure flies in, such that the flies may subsequently be trapped on an adhesive board to be then manually inspected and counted by a pest control technician. Conventionally, a pest control technician may be required to visit the space periodically and count the number of flies captured on the adhesive board. Manual inspection of any capture area, whether associated with pests or other objects, may be time-consuming, labor-intensive, and prone to human error.

This background information is provided to reveal information believed by the applicant to be of possible relevance to the present invention. No admission is necessarily intended, nor should be construed, that any of the preceding information constitutes prior art against the present invention.

### SUMMARY

The process of in-person manually counting of objects in a capture area (e.g., pests) at a singular moment in time may be inefficient and prone to errors. In an example, manual inspections of pest-control capture apparatuses often require accessing pest-control capture apparatuses (e.g., fly lights or adhesive boards) in hard-to-reach places, which may require the use of ladders and potentially shutting down customer sites during these inspections. Additionally, there may be a delayed response to pest contamination, as a technician may not promptly address sudden increases in pest populations. A technician will likely miss pest activity that occurs during the period between conventional manual inspections.

Technicians in-person manual counting or object detection algorithms may mistakenly interpret dust specks or other debris as the target object (e.g., insect, rodent, or other target objects) when they overlap with background grid lines, or multiple objects. Additionally, structural elements on or approximate to the capture area, such as struts, edges, or fasteners, may partially obscure objects, leading to undercounting. Variations in lighting conditions and shadows can further complicate accurate object detection and counting.

Disclosed herein are methods, devices, or systems that may allow for remote monitoring of a capture area or the automatic inspection of a capture area, such as an adhesive board, among other things. Aspects may include techniques for excluding background elements, handling partially obscured objects, or generating spatial models to preserve relative object sizes or positions.

In one aspect, the disclosed subject matter may include receiving an image from a sensor associated with an area, determining and removing background elements associated with the apparatus, and generating a cleaned image. Objects are then detected in this cleaned image. A spatial partition model is generated based on the cleaned image to understand z-index and partially obscured areas while preserving relative object sizes. This model is used to determine and remove foreground elements that may obstruct (e.g., significant or complete blockage) or obscure (e.g., a partial blockage) objects of interest. After removing foreground elements, object detection is performed again on the further cleaned image. Detected objects are filtered based on predefined criteria for different object classes. Finally, count statistics are generated for the detected and classified objects. The disclosed subject matter may enable more accurate automated inspection and counting of insects and other objects by intelligently handling background interference, occlusions, and other visual challenges.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1A is an exemplary system associated with the disclosed subject matter;

FIG. 1B is an exemplary system that includes a cloud platform associated with the disclosed subject matter;

FIG. 2 illustrates an exemplary wide-angle image;

FIG. 3 illustrates an exemplary flattened image version of the wide-angle image;

FIG. 4 illustrates an exemplary system for image analysis;

FIG. 5 illustrates an exemplary object detection that considers pest size or pest classification;

FIG. 6 is an exemplary method for obtaining or processing object-related information;

FIG. 7 illustrates an exemplary image of a capture area with occlusion.

FIG. 8 illustrates an exemplary method for detecting and counting objects in images associated with a capture area.

FIG. 9 is an exemplary block diagram representing a general-purpose computer system in which aspects of the methods or systems disclosed herein or portions thereof may be incorporated.

### DETAILED DESCRIPTION

Accurately counting specific insect types on adhesive boards or other capture areas present several challenges. In an example associated with insects, the captured insects may vary in size, orientation, or degree of overlap. Debris or non-target insects may be present, complicating the identification or counting process. Some approaches lack the ability to reliably differentiate between object classes or handle complex foregrounds or backgrounds. Background or foreground elements like grid patterns, textures, or structural components of the device can be mistakenly interpreted as insects or obscure actual insects from view, leading to undercounting or misclassification. Variations in lighting conditions can cast shadows or create glare, further complicating the task of accurately identifying and counting insects on the device. There is a need for more robust and flexible artificial intelligence (AI)-powered methods or systems that may process object sets across diverse image contexts.

The disclosed subject matter may help address these challenges by providing a sophisticated image processing and object recognition system specifically tailored for use with various capture areas, such as pest control devices. A capture area as disclosed herein may be any physical area or area designated digitally to be of significance for analysis. The capture area may be captured by a sensor such as a camera. A multi-step approach may be employed to clean the image of interfering elements, handle partially obscured objects, and maintain accurate spatial relationships between detected objects.

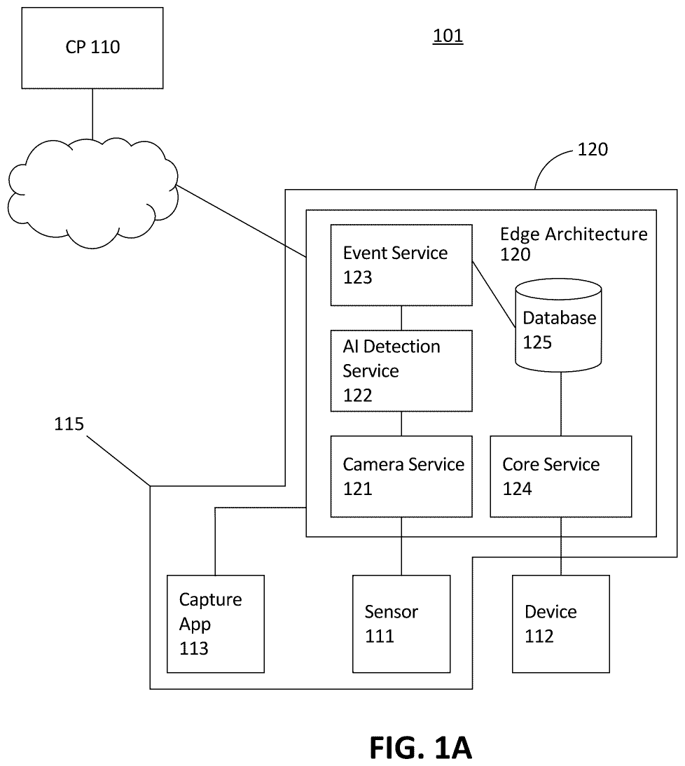

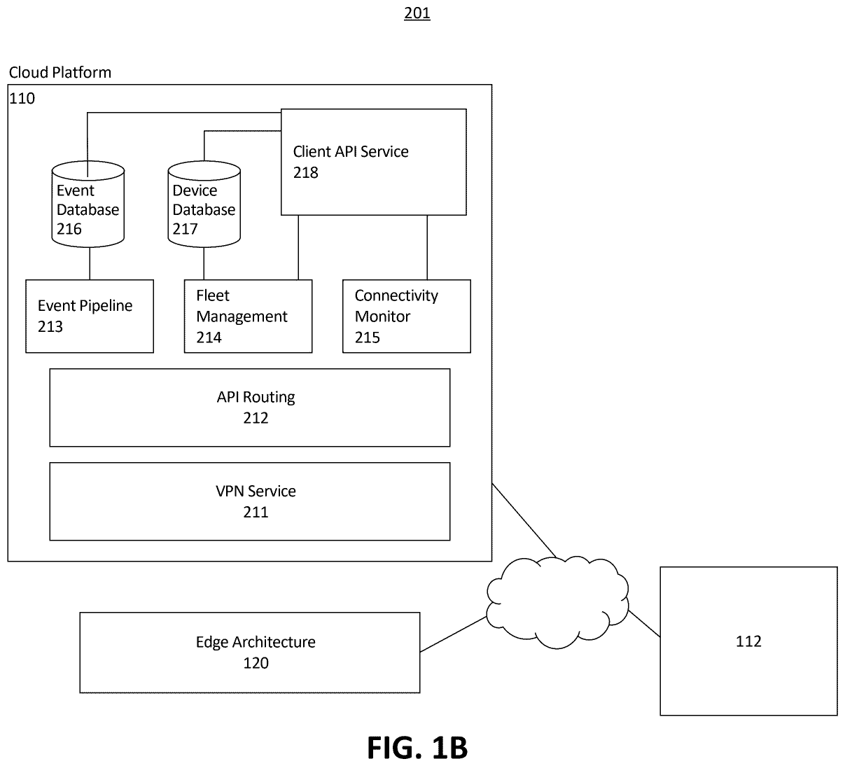

FIG. 1A is an exemplary system 101 associated with a connected pest-control apparatus 115. System 101 may include cloud platform (CP) 110, edge architecture 120, sensor 111 (e.g., camera or another sensor), device 112 (e.g., a mobile device or computer), or pest-control capture apparatus 113 (e.g., fly light), which may be communicatively connected with each other. Connected pest-control apparatus 115 (e.g., connected fly light) as referred to herein may include the following components: pest-control capture apparatus 113, sensor 111, and one or more components of edge architecture 120. Edge architecture 120 may handle tasks such as video frame processing from sensor 111, artificial intelligence-driven pest detection and metrics, or connectivity and configuration management, among other things. It is contemplated that the functions disclosed herein may be executed in one device or distributed over multiple devices.

CP 110 may be one or more devices that handle communications or administration of a network of connected pest-control apparatuses 115 (e.g., fly lights), navigate between application programing interfaces (APIs) for client access to pest-related information (e.g., fly light performance), receive pest detection events, process pest detection events, or store pest detection events, among other things. CP 110 is described in more detail in FIG. 1B.

Sensor 111 may collect video footage of the strategically positioned pest-control capture apparatus 113, such as an adhesive board, that collects pests (e.g., flies or rodents). Sensor service 121 may manage the acquisition of video frames from sensor 111, which may include camera calibration to ensure optimal image capture, periodic capture of video frames at pre-defined intervals, or the storage of video frames in a shared database (e.g., database 125) for later artificial intelligence processing, which may be executed by AI detection service 122.

Edge architecture 120 may include sensor service 121, artificial intelligence (AI) detection service 122, event service 123, core service 124, or database 125. AI detection service 122 may be responsible for the following: 1) hardware-accelerated image decoding for efficient video retrieval; 2) remapping of a wide angle (e.g., fish-eye image to a flattened image for better pest recognition); 3) real-time AI model inference for pest counting or size classification, or 4) post-processing of detection result or storing results in a shared database (e.g., database 125).

Event service 123 may generate event related information, such as image-based event information, based on the pest detection results. In an example, each event may be associated with a high-definition image. Each image-based event may have associated AI detection metadata, which may include pest location, bounding box coordinates, confidence scores, or size classification. Such events may be uploaded to CP 110, as described in further detail in the description of FIG. 1B, for future analysis, alerting, or notification.

Core services 124 may include multiple applications that act as a system for tasks such as onboarding, configuration, connectivity, software updates, or overall management of a connected pest-control apparatus 115. Core services 124 may serve to communicate with the other connected pest-control apparatus 115 in their given network. Core services 124 may utilize Bluetooth connectivity to communicate with device 112 and may communicate with CP 110. Onboarding may be the task of setting up a new connected pest-control apparatus 115 and connecting to CP 110. To perform initial onboarding of the connected pest-control apparatus 115, a mobile app running on device 112 may connect to the connected pest-control apparatus 115 via a Bluetooth interface, allowing a user to perform onboarding functions such as configuring network settings to connect devices associated with the connected pest-control apparatus 115 to the internet or to download software updates.

Database 125 may serve to store pest-related information as collected from devices associated with connected pest-control apparatus 115.

Device 112 may be a mobile phone, laptop, or other apparatus. Device 112 may interact with core services 124 for administrative purposes, which may include onboarding, configuration, connectivity, software updates, or general management of the network of connected pest-control apparatuses 115.

FIG. 1B is an exemplary system 201 that may include cloud platform 110 associated with a connected pest-control apparatus 115. Illustrated in FIG. 1B is a representation of the cloud architecture that may connect the network of connected pest-control apparatuses 115 or organize the pest-related characteristics collected by connected pest-control apparatus 115 in a portal API for web or mobile management. System 201 of FIG. 1B may include edge architecture 120, CP 110, or device, which may be communicatively connected with each other.

The devices or functions of edge architecture 120 may monitor pest detection or capture pest-related metrics through the use of artificial intelligence or manage connectivity and configuration between the connected pest-control apparatuses 115, among other things. Edge architecture 120 is described in more detail herein.

CP 110 may include virtual private network (VPN) service 211, API routing 212, event pipeline 213, fleet management system 214, connectivity monitor 215, event database 216, device database 217, or client API service 218 (e.g., client API routing). It is contemplated that the functions disclosed herein may be executed in one or more devices.

VPN service 211 may handle the network communications for the network of connected pest-control apparatuses 115 through secure or encrypted VPN tunnels.

API routing 212 may be responsible for routing API requests originating from connected pest-control apparatuses 115. Connected pest-control apparatus 115 or other associated devices may make requests based on pest detection, connectivity issues, or fleet management-related queries, among other things.

Event pipeline 213 may manage the process of ingesting, routing, processing, or storing pest detection events. The product of event pipeline 213 may be directed toward client API service 218 to be used in real-time analytics for user consumption.

Fleet management system 214 may include services responsible for the management of the connected pest-control apparatuses 115. An interface may be provided for these services for performing administrative tasks or accessing the direct network for real time changes. Administrative tasks may include device onboarding or configuration changes like naming and location updates. Fleet management system 214 may provide for direct network access for near real-time changes, such as data upload intervals or monitoring real-time status; for example, resource usage of the single-board computer (SBC) or Wi-Fi metrics. Real-time changes may include altering the time between data uploads and monitoring the real-time status of the data.

Connectivity monitor 215 may monitor the network health of the connected pest-control apparatuses 115 or provide an interface for accessing the connectivity status of connected pest-control apparatuses 115.

The event database 216 may serve as an intermediary to store product of the event pipeline 213, or other information.

The device database 217 may serve as an intermediary to store product of the fleet management system 214, or other information.

The client API service 218 may serve as an interface for management applications or third-party integration APIs. The client API service 218 may communicate with device 112 to allow for access to pest count data, access to adhesive board images, check connectivity status, or customize settings and alerts associated with connected pest-control apparatus 115. Users may utilize this management application to gain real-time insights into the adhesive board environment. From this application, users may access trend analysis of datasets produced by the client API service 218 or generate reports of the data as needed.

In an example scenario, data associated with pest control capture apparatus 113 may be collected via sensor 111 and the collected data may be managed by sensor service 121. Then, the data (e.g., video footage, still picture, or infrared image) may be processed via deep learning-based object detection algorithm, e.g., using AI 122, which may result in AI detection metadata. Event service 123 may combine images from the video footage with the AI detection metadata to create image-based events based on the results of the object detection algorithm. Those image-based events may then be uploaded to CP 110, for future analysis, alerting, or notification. Event pipeline 213 may receive, route, process, or store the data (e.g., image-based events information, snaps of video footage, or AI detection metadata). The event pipeline 213 may feed the results of its analysis to client API service 218. CP 110 may be used for administrative purposes, such as checking the strength of the network connecting connected pest-control apparatuses 115 or the status of an individual connected pest-control apparatus 115.

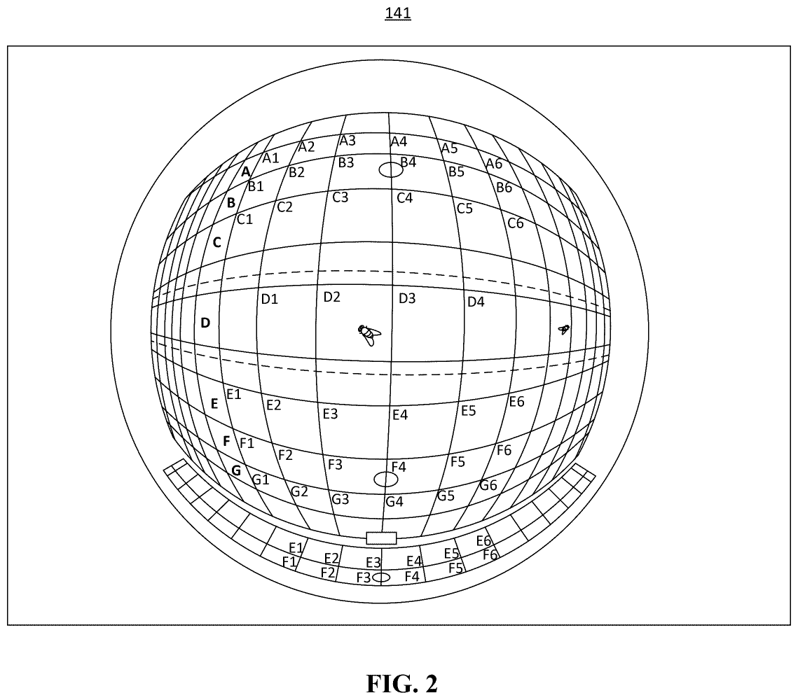

FIG. 2 illustrates an exemplary wide-angle image, which may be on a live image from sensor 111. Sensor 111 may be wide-angled and may be optimized or positioned by sensor service 121 to capture video footage of the adhesive board. An object detection algorithm associated with AI detection service 122 may be used to highlight the pests in the image.

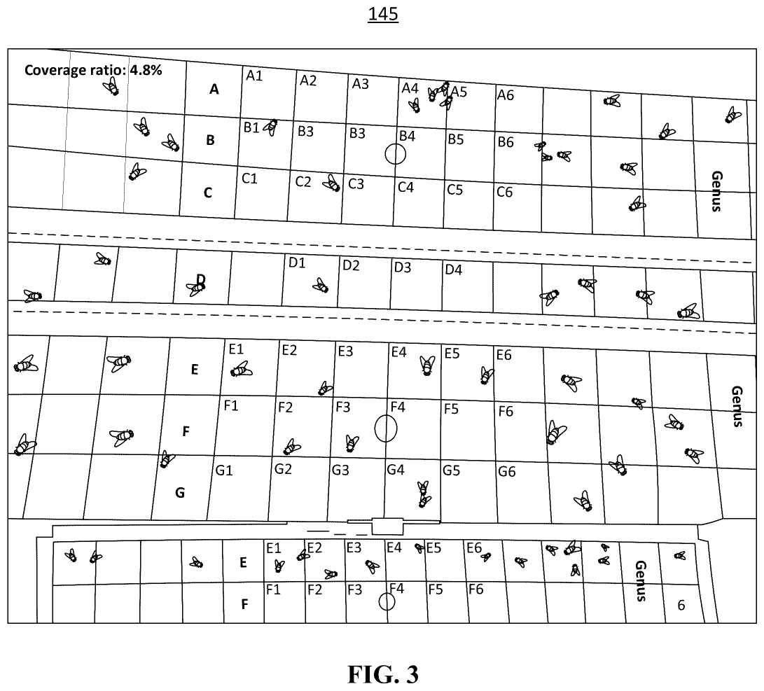

FIG. 3 is a flattened image version of the wide-angle image illustrated in FIG. 2. Positioned flat, the image may exhibit distortions, which may require processing to realign the image to a coherent physical plane. The flattened image as depicted in FIG. 3 may help in the use of enhanced feature detection of pests.

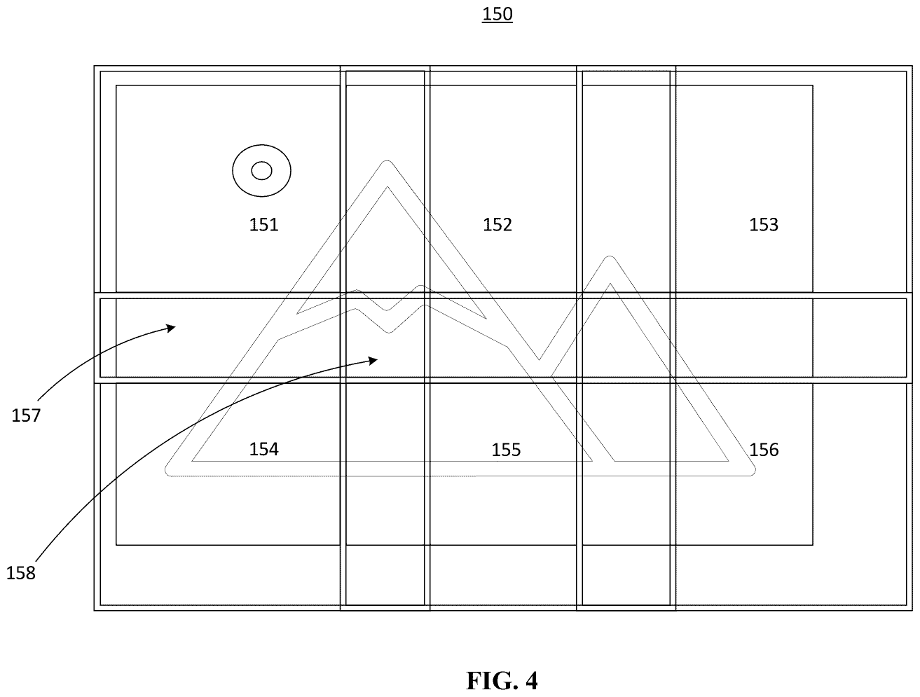

FIG. 4 illustrates an exemplary system for image analysis. In an example, the object detection model may use raw imagery, as depicted in FIG. 3, to be segmented into distinct blocks, e.g., 6 distinct blocks as illustrated in FIG. 4. Upon segmentation, each block may undergo individual object detection, after which the algorithm may consolidate each block's count for a final tally of pests captured on the adhesive board. The six distinct blocks share some overlap, which may ensure that the pests placed in two or more blocks be considered in the calculation.

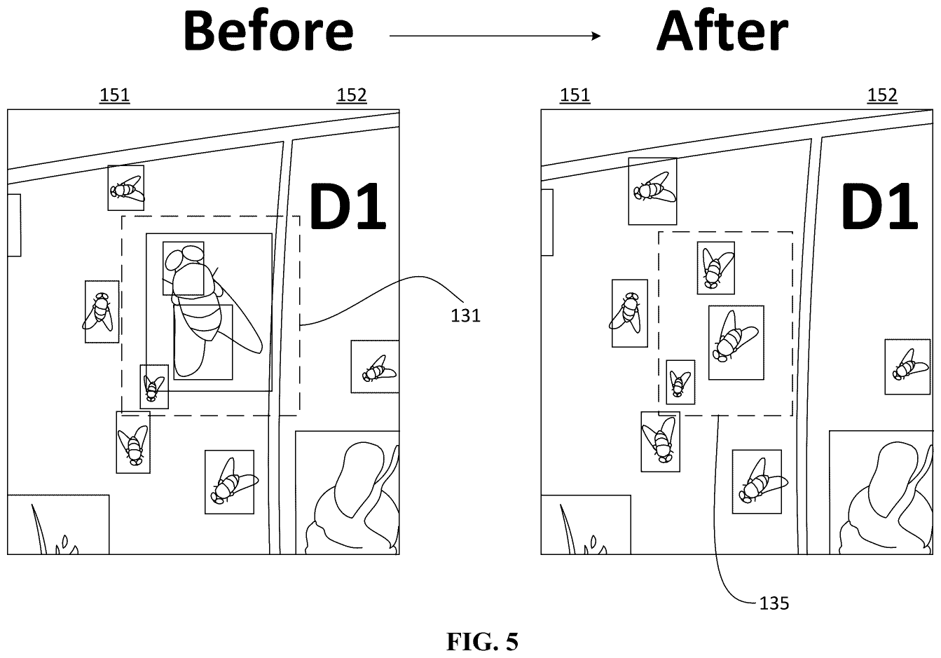

FIG. 5 illustrates an exemplary object detection that considers pest size or pest classification. Beyond mere enumeration, the disclosed subject matter offers size categorization for each detected pest. The system may measure the bounding box dimensions of detected entities (e.g., bounding box 131). To counteract potential image distortions stemming from wide-angle capture devices, the system may employ coordinate-based transformations restoring the bounding box to its true dimension (e.g., multiple bounding boxes as shown in bounding box 135). Size classifications may be ascertained from these rectified bounding boxes. Using these box dimensions also may allow for a better gauge of the comprehensive area of the adhesive board.

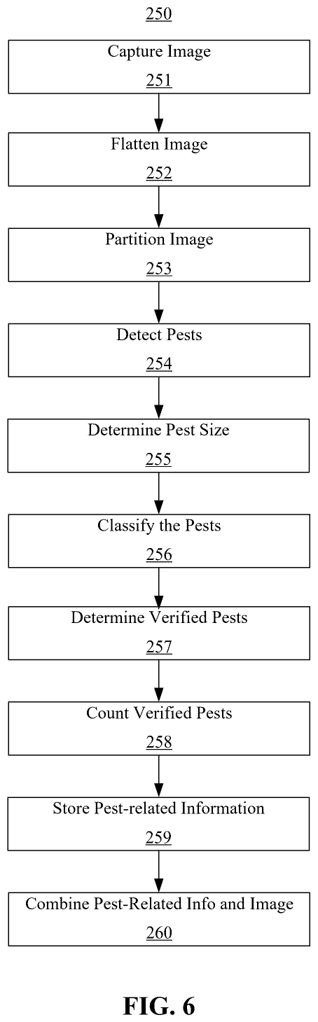

FIG. 6 illustrates an exemplary method 250 for collecting pest-related information from a video-capturing device. Such information may be transformed into usable data on a user portal.

At block 251, sensor 111 may capture image 141 of pest control capture apparatus 113 (e.g., adhesive board). Image 141 may be wide-angle image 141.

At block 252, image 141 may be altered to be flattened image 145. Flattened image 145 may further processed to remove any distortions.

At block 253, flattened image 145 may be processed by an object detection model associated with AI detection service 122. The object detection model associated with AI detection service 122 may partition flattened image 145 (e.g., FIG. 3) into a plurality of distinct segments (e.g., segment 151 through segment 156 in image 150 of FIG. 4). Each segment may overlap with one or more segments. For example, segment 151 may overlap with segment 154 to create overlap 157. In another example, segment 151, segment 152, segment 154, and segment 155 may overlap to create overlap 158.

At block 254, one or more pests are detected in each segment, such as segment 151 through segment 156.

At block 255, determine size of a first detected pest. For each individual segment of flattened image 145, the model may consider pest size or pest classification as depicted in FIG. 5 or historical data from prior image to assess pest routes and prevent overcalculation.

At block 256, classify the first detected pest (e.g., fly, ant, etc.). At block 257, determine, based on a comparison of historical information of a pest classification and the determined size (at block 255) and classification at block 256, a number of verified pests. In an example, a verified pest may be determined to have threshold confidence level.

At block 258, upon analysis of an individual segment (e.g., segment 151), a count may be tallied of the verified pests captured with pest-control capture apparatus 113 at segment 151.

At block 259, store the pest-related information that comprises the count of pests, the classification of pests, or the size of the pest, among other things.

At block 260, the pest-related information (e.g., the number of flies on an adhesive board), may be combined with snippets within the image to be image-based events that are uploaded to CP 110. In CP 110, the image-based events may be ingested, routed, processed, and analyzed within the event pipeline 213. The analysis of such image-based events of method 250 may be mapped for use and consideration in a portal accessible to users. Method 250 may be performed by computing equipment including mobile devices (e.g., tablet computers), servers, or any other device that can execute computing functions.

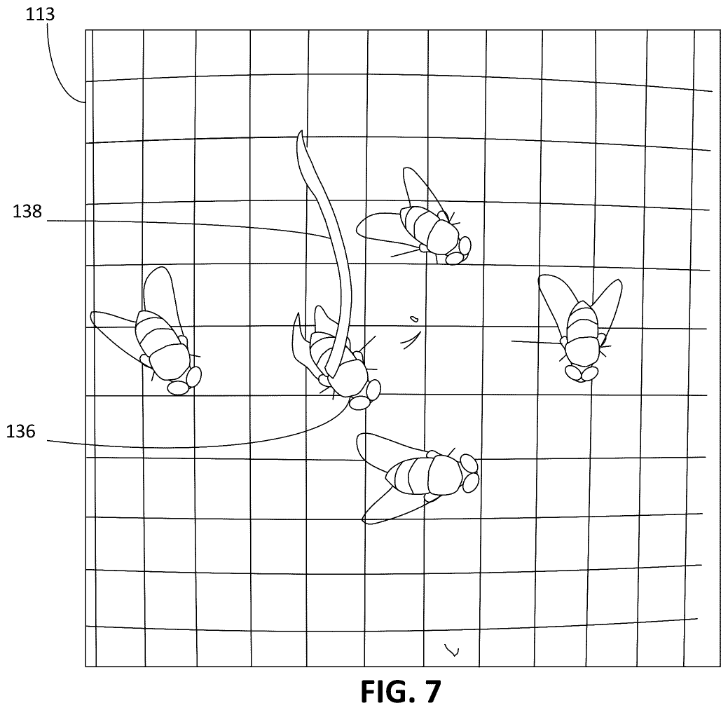

FIG. 7 illustrates an exemplary image of pest-control capture apparatus 113 in which there are multiple captured insects 136 and occlusion 138 (e.g., a wire or twig) that may obscure captured insect 136.

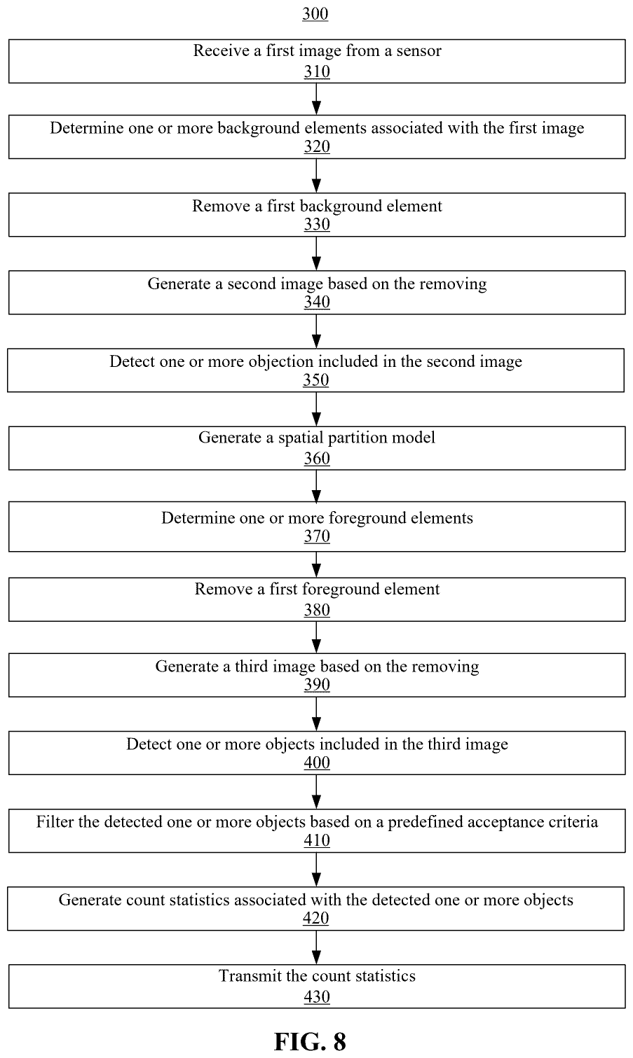

FIG. 8 illustrates a method flow depicting the steps of an exemplary method 300 for detecting and counting objects in images associated with a pest-control capture apparatus. The disclosed subject matter may overcome the challenges associated with automated inspection of pest-control capture apparatuses 113, such as in situations where background elements, occlusions, or lighting conditions may interfere with accurate object detection and counting.

At step 310, a first image may be received from sensor 111 associated with connected pest-control apparatus 115. Sensor 111 may be a digital camera positioned to capture high-resolution images of pest-control capture apparatus 113, such as a fly light trap with an adhesive board. Sensor 111 may be other types of sensors that may be capable of capturing sufficient details of the area associated with pest-control capture apparatus 113. The image may be received in various formats, such as Joint Photographic Experts Group (JPEG), Portable Network Graphics (PNG), or RAW, depending on the capabilities of sensor 111 and the requirements of system 101 or system 201.

At step 320, the one or more background elements associated with the first image that are related to pest-control capture apparatus 113 may be determined. This step may help identify elements of the image that are not objects of interest (such as insects) but rather parts of pest-control capture apparatus 113 itself. Background elements may include grid lines on pest-control capture apparatus 113, textures or patterns on the surface of pest-control capture apparatus 113, structural components of pest-control capture apparatus 113 (e.g., edges, corners), labels or markings on pest-control capture apparatus 113, or reflective surfaces that may cause glare, among other things. Textures may include ridges, grooves, perforations, embossed patterns, or ultraviolet degraded surfaces, among other things.

The determination of these background elements may involve various image processing techniques, such as edge detection, pattern recognition, or color-based segmentation. Machine learning algorithms trained on a dataset of images associated with pest-control capture apparatus 113 may also be employed to identify common background elements accurately.

Step 330, when background elements are identified, may involve removing a first background element from the image, such as one or more gride lines. This removal process may eliminate elements that may interfere with accurate object detection without distorting the spatial relationships or sizes of potential objects of interest. The choice of which background element to remove first may depend on factors such as the element's prominence in the image, the element's potential (e.g., threshold probability or confidence) for causing false positives in objects, or the element's case of removal without affecting nearby pixels that may contain objects of interest. The removal process may use techniques such as inpainting algorithms to fill in the area of the removed element, mask-based approaches to exclude the element from further processing, or color-based filtering to remove elements of a specific color range, among other things. The method may include steps to ensure that the removal process does not inadvertently eliminate or alter pixels that may represent actual insects or other objects of interest.

Step 340 may involve generating a second image based on the removal of the first background element. This second image may represent a cleaner version of the original (e.g., image of step 310), with reduced interference from the structural elements of connected pest-control apparatus 115. The generation of this image may involve applying the removal mask or algorithm to the original image, adjusting contrast or brightness to compensate for artifacts introduced by the removal process, or sharpening or other enhancement techniques to improve the visibility of potential objects of interest. The second image may maintain the overall structure and scale of the original image while minimizing the presence of the removed background element.

At step 350, the one or more objects included in the second image may be detected. This initial object detection step employs computer vision and machine learning techniques to identify potential insects or other objects of interest. The detection process may involve convolutional neural networks (CNNs) trained on insect images, computer vision techniques such as blob detection or contour analysis, or color/shape-based filtering to identify objects. The output of this step 350 may include a list of potential objects, each with associated metadata such as position, size, and confidence score.

At step 360, a spatial partition model may be generated based on the second image. This model may help with understanding the z-index (depth ordering) of elements in the image and identifying at least partially obscured areas while preserving the relative sizes of the detected objects. The spatial partition model may be implemented as a two-layer z-index, with one layer for the area associated with pest-control capture apparatus 113 and another layer for other objects (e.g., pests). Alternatively, the spatial partition model may be implemented as a more complex full z-index that accounts for multiple layers of occlusion. The spatial partition model may be implemented as a 3D spatial model that estimates the position of objects in three-dimensional space.

The spatial partition model may take into account the known structure of connected pest-control apparatus 115, the positions of detected objects, or any shadows or lighting variations that may indicate depth. This step 360 may be in helpful in cases where pests may be partially obscured by pest-control capture apparatus, other pests, or obstructions.

Using the spatial partition model, step 370 determines one or more foreground elements associated with the second image that obstruct or obscure the pest-control capture apparatus. These foreground elements may include physical objects like struts or protective covers, shadows cast by structural elements, dust, debris, or other particles on the surface associated with pest-control apparatus 115, or glare or reflections from lighting conditions. Foreground elements may be the parts that are closest to sensor 111, while background elements are usually the parts that are furthest away and generally closer to pest-control capture apparatus 113.

The determination of foreground elements may rely on the spatial partition model to distinguish between elements that are part of the pest-control apparatus (background) and those that are obstructing the view of potential objects of interest (foreground).

At step 380, one or more foreground elements may be removed from the second image. This removal process may reveal any objects that may have been partially obscured by the foreground element. The removal technique may vary depending on the nature of the foreground element. For solid objects, inpainting techniques may be used to estimate the appearance of obscured areas. For shadows, lighting compensation algorithms may be applied. For dust or debris, small object removal filters may be employed.

At step 390 a third image may generate based on the removal of the first foreground element. This third image may be a cleaner version of the second image with both background and foreground interference reduced. The generation of this image may involve applying the foreground removal algorithm to the second image; blending the revealed areas smoothly with the surrounding image content; or adjusting overall image parameters to ensure consistency in lighting and contrast.

The resulting third image may provide a clearer view of potential objects of interest, with minimal interference from both background and foreground elements associated with connected pest-control apparatus 115.

At step 400, object detection may be performed on the third image. This second round of object detection may identify objects that may have been missed or misclassified in the initial detection due to interference from background or foreground elements. The detection process may use the same algorithms as in step 350, but with adjusted parameters to account for the cleaner image; use additional detection methods that may be more effective on the cleaner image; use a comparison with the results from step 350 to identify newly revealed objects or confirm previously detected ones. This step 400 may involve merging detection results from step 350 and step 400 to create a comprehensive list of detected objects.

At step 410, the detected objects may be based on predefined acceptance criteria associated with one or more classes. This filtering step may help eliminate false positives and categorize detected objects into appropriate classes (e.g., different types of pests). The filtering criteria may include size ranges for different types of pests, shape characteristics specific to certain pest species, color patterns associated with particular pests, or probability thresholds based on the confidence scores from a detection algorithm. The filtering process may also take into account the spatial relationships between detected objects, using the spatial partition model to reject detections that are physically implausible (e.g., overlapping insects).

At step 420, count statistics may be generated for the detected and classified objects. These statistics may provide a quantitative summary of the pest situation captured by the first image. The statistics may include total counts for each object class (e.g., different types of pests); size distributions within each class; spatial distribution of detected objects across the pest-control capture apparatus 113; comparison with historical data to identify trends or anomalies; or confidence intervals or uncertainty estimates for the counts.

The generation of these statistics may involve statistical analysis techniques to provide not just raw counts but also meaningful insights into the pest population captured by connected pest-control apparatus 115.

At step 430, the count statistics may be transmitted. This transmission may be to a database for storage or analysis; a user interface for immediate display to pest-control operators; an alert system that may send notifications regarding significant findings; or other systems for further analysis or integration with broader pest management strategies.

The disclosed subject matter provides an approach associated with challenges of automated inspection of pest-control apparatuses. By systematically addressing issues of background interference, partial occlusion, and variability in lighting conditions, there may be accurate and reliable counting of captured pests. The multi-stage approach, with repeated object detection on progressively cleaner images, may help to minimize both false positives and false negatives. The incorporation of a spatial partition model may allow the system to maintain accurate spatial understanding even as interfering elements are removed from captured images.

The disclosed subject matter provides for a deep learning-based object detection model that may be trained to recognize flies or other pests on pest-control capture apparatus 113 (e.g., a glue board). Upon detecting, the system (e.g., AI detection service 122 or function herein of system 101 or system 201) may quantify pests surpassing a predetermined threshold to ascertain the total number present on said glue board. A model may be trained using diversified datasets, which may include open-source insect repositories; datasets obtained through internet crawling, images of glue boards derived from conventional pest traps; laboratory-acquired images using the hardware delincated in this disclosure; or field-sourced glue board images utilizing the aforementioned hardware.

Training of the model may be compromised by limited availability and quality of pest imagery. To mitigate challenges stemming from the extensivity of the datasets, data augmentation methods may be employed, which may involve: rotation of training visuals; image cropping techniques; or color grade enhancements. Through these augmentation measures, the system may ensure enriched training datasets, which may enhance visual feature extraction capabilities. Additionally, to address data inadequacies, data synthesis techniques may be integrated to construct training images for pest-control capture apparatuses by amalgamating pest images with those of unoccupied adhesive boards.

To optimize the object detection capabilities of the system and confront images with an abundance of objects, the disclosed system may introduce tailored tuning of model parameters to proficiently manage multiple objects simultaneously.

To address the problem of distortions in the raw imagery, given by the nature of the hardware posited herein, transformative measures may be applied to these images to realign them to a coherent physical plane. This may enhance feature detection of pests.

Traditional object detection algorithms only consider the current image, which poses a challenge when counting pests because pests may overlap with each other. By looking at just the current image, the system may under count or be unable to detect the present pests. To address such challenge, the system may implement a history based counting optimization, where a confidence score may be assigned to each detected pest based on the amount of time it has been consistently detected in history. From that, the system may generate the final count by merging the weighted historical count with the count of the current image.

Another approach to attacking the challenge of pests overlapping with each other on camera may be additional consideration of pest size. Beyond mere enumeration, the disclosed subject matter may offer size categorization for each detected pest. The system measures the bounding box dimensions of detected entities. To counteract potential image distortions stemming from wide-angle capture devices, the system may employ coordinate-based transformations restoring the bounding box to its true dimension. Size classifications may be ascertained from these rectified bounding boxes.

The disclosed subject matter may have the ability to gauge adhesive board or other pest-control capture apparatus occupancy percentages through remote surveillance. The occupancy rate may be determined by evaluating combined areas of bounding boxes relative to the comprehensive area of the pest-control capture apparatus.

In an example, the data collection may be through camera footage or fusion of other sensors, which may include temperature/humidity sensors, to gain more accurate environmental conditions. In another example, cleaning mechanisms may be implemented to clean the camera and additional sensors automatically. The disclosed subject matter may combine historical data, location, seasonal information, or weather data to predict patterns in pest movement or presence. The disclosed subject matter may generate increased characteristics that are descriptive of one or more pests. The characteristics currently include number of pests, but connected pest-control apparatuses 115 may utilize artificial intelligence to identify the species of pests captured by the pest-control capture apparatus 113. Although flies are referenced herein, it is contemplated that the disclosed subject matter be applicable to other insects or other pests. The disclosed subject matter may provide a more comprehensive understanding of infestations across a larger area by allowing direct sharing of data and insights between connected pest-control apparatuses 115 in a geographic location or network.

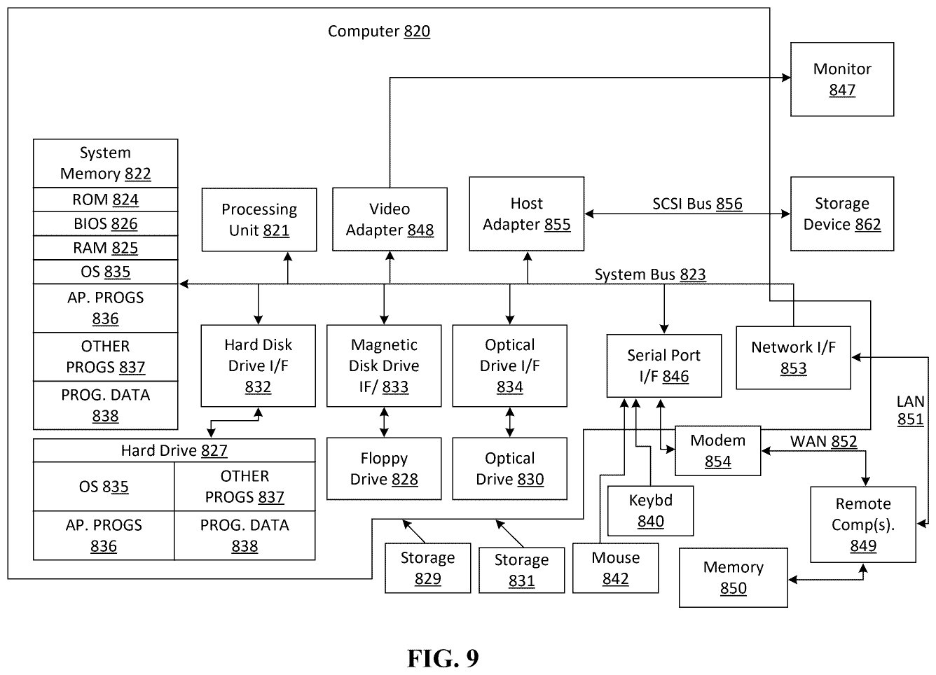

FIG. 9 and the following discussion are intended to provide a brief general description of a suitable computing environment in which the methods and systems disclosed herein and/or portions thereof may be implemented. Although not required, the methods and systems disclosed herein is described in the general context of computer-executable instructions, such as program modules, being executed by a computer, such as a client workstation, server, personal computer, or mobile computing device such as a smartphone. Generally, program modules include routines, programs, objects, components, data structures and the like that perform particular tasks or implement particular abstract data types. Moreover, it should be appreciated the methods and systems disclosed herein and/or portions thereof may be practiced with other computer system configurations, including hand-held devices, multi-processor systems, microprocessor-based or programmable consumer electronics, network PCs, minicomputers, mainframe computers and the like. The methods and systems disclosed herein may also be practiced in distributed computing environments where tasks are performed by remote processing devices that are linked through a communications network. In a distributed computing environment, program modules may be located in both local and remote memory storage devices.

FIG. 9 is a block diagram representing a general purpose computer system in which aspects of the methods and systems disclosed herein and/or portions thereof may be incorporated. As shown, the exemplary general purpose computing system includes a computer 820 or the like, including a processing unit 821, a system memory 822, and a system bus 823 that couples various system components including the system memory to the processing unit 821. The system bus 823 may be any of several types of bus structures including a memory bus or memory controller, a peripheral bus, and a local bus using any of a variety of bus architectures. The system memory includes read-only memory (ROM) 824 and random access memory (RAM) 825. A basic input/output system 826 (BIOS), containing the basic routines that help to transfer information between elements within the computer 820, such as during start-up, is stored in ROM 824.

The computer 820 may further include a hard disk drive 827 for reading from and writing to a hard disk (not shown), a magnetic disk drive 828 for reading from or writing to a removable magnetic disk 829, and an optical disk drive 830 for reading from or writing to a removable optical disk 831 such as a CD-ROM or other optical media. The hard disk drive 827, magnetic disk drive 828, and optical disk drive 830 are connected to the system bus 823 by a hard disk drive interface 832, a magnetic disk drive interface 833, and an optical drive interface 834, respectively. The drives and their associated computer-readable media provide non-volatile storage of computer readable instructions, data structures, program modules and other data for the computer 820. As described herein, computer-readable media is an article of manufacture and thus not a transient signal.

Although the exemplary environment described herein employs a hard disk, a removable magnetic disk 829, and a removable optical disk 831, it should be appreciated that other types of computer readable media which can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), and the like.

A number of program modules may be stored on the hard disk, magnetic disk 829, optical disk 831, ROM 824 or RAM 825, including an operating system 835, one or more application programs 836, other program modules 837 and program data 838. A user may enter commands and information into the computer 820 through input devices such as a keyboard 840 and pointing device 842. Other input devices (not shown) may include a microphone, joystick, game pad, satellite disk, scanner, or the like. These and other input devices are often connected to the processing unit 821 through a serial port interface 846 that is coupled to the system bus, but may be connected by other interfaces, such as a parallel port, game port, or universal serial bus (USB). A monitor 847 or other type of display device is also connected to the system bus 823 via an interface, such as a video adapter 848. In addition to the monitor 847, a computer may include other peripheral output devices (not shown), such as speakers and printers. The exemplary system of FIG. 9 also includes a host adapter 855, a Small Computer System Interface (SCSI) bus 856, and an external storage device 862 connected to the SCSI bus 856.

The computer 820 may operate in a networked environment using logical connections to one or more remote computers, such as a remote computer 849. The remote computer 849 may be a personal computer, a server, a router, a network PC, a peer device or other common network node, and may include many or all of the elements described herein relative to the computer 820, although only a memory storage device 850 has been illustrated in FIG. 9. The logical connections depicted in FIG. 9 include a local area network (LAN) 851 and a wide area network (WAN) 852. Such networking environments are commonplace in offices, enterprise-wide computer networks, intranets, and the Internet.

When used in a LAN networking environment, the computer 820 is connected to the LAN 851 through a network interface or adapter 853. When used in a WAN networking environment, the computer 820 may include a modem 854 or other means for establishing communications over the wide area network 852, such as the Internet. The modem 854, which may be internal or external, is connected to the system bus 823 via the serial port interface 846. In a networked environment, program modules depicted relative to the computer 820, or portions thereof, may be stored in the remote memory storage device. It will be appreciated that the network connections shown are exemplary and other means of establishing a communications link between the computers may be used.

Computer 820 may include a variety of computer readable storage media. Computer readable storage media can be any available media that can be accessed by computer 820 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media is physical structure that is not a signal per se. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 820. Combinations of any of the above should also be included within the scope of computer readable media that may be used to store source code for implementing the methods and systems described herein. Any combination of the features or elements disclosed herein may be used in one or more examples. The terms machine learning (ML), deep learning, or artificial intelligence (AI) may be used interchangeably herein.

Additionally, contrary to conventional computing systems that use central processing units (CPUs), in some examples the disclosed connected pest-control system(s) may primarily use graphics processing units (GPUs), field-programmable gate arrays (FPGAs), or application-specific integrated circuits (ASICs), which may be referenced herein as AI chips, for executing the disclosed methods. Unlike CPUs, AI chips may have optimized design features that may dramatically accelerate the identical, predictable, independent calculations required by AI applications or AI algorithms. These algorithms may include executing a large number of calculations in parallel rather than sequentially, as in CPUs; calculating numbers with low precision in a way that successfully implements AI applications or AI algorithms but reduces the number of transistors needed for the same calculation(s); speeding up memory access by, for example, storing an entire AI application or AI algorithm in a single AI chip; or using programming languages built specifically to efficiently translate AI computer code for execution on an AI chip.

The object detection model exercised by AI detection service 122 analyzes one singular frame, FIG. 3, in smaller frames (e.g., 156), which is described in more detail in FIG. 4. This image pre-processing is an example of the AI chip's programming to create a more detailed calculation and produce more accurate results. Different types of AI chips are useful for different tasks. GPUs may be used for initially developing and refining AI applications or AI algorithms; this process is known as “training.” FPGAs may be used to apply trained AI applications or AI algorithms to real-world data inputs; this is often called “inference.” ASICs may be designed for either training or inference. The AI detection service 122 may exercise a model trained using diversified datasets, which may encompass open-source insect repositories, images of adhesive boards derived from conventional fly traps, lab-acquired adhesive board images, or field-sourced adhesive board images utilizing the hardware of connected pest-control apparatuses 115.

Methods, systems, or apparatus with regard to object image analysis are disclosed herein. The disclosed methods, systems, or apparatus with regard to obscured object recognition when viewing a pest-control apparatus may include receiving a first image from a sensor, the sensor associated with and in proximity to a capture area (e.g., pest-control capture apparatus); determining one or more background elements associated with the first image that are associated with the pest-control capture apparatus; removing a first background element of the one or more background elements; generating a second image based on the removing of the first background element of the one or more background elements; detecting one or more objects included in the second image; generating, based on the second image, a spatial partition model associated with understanding a z-index and at least a partially obscured area while preserving the relative sizes of the one or more objects; determining, based on the spatial partition model, one or more foreground elements associated with the second image that obstructs or obscures the pest-control capture apparatus in the second image; removing a first foreground element of the one or more background elements; generating a third image based on the removing of the first foreground element of the one or more foreground elements; detecting one or more objects included in the third image; filtering the detected one or more objects based on a predefined acceptance criteria associated with one or more classes; generating count statistics associated with the detected one or more objects in the one or more classes; and transmitting the count statistics. Proximity may be a distance in which the sensor may sense (e.g., capture an image) of the pest-control capture apparatus. Although an example is provided associated with a pest-control capture apparatus, it is contemplated herein that this may be broadly applicable to any capture area and targeted objects within. A targeted object may vary and may include non-living objects (e.g., stones in a creek or types of suitcases on a conveyor) or living objects (e.g., fish in the creek or rodents on a glue board). Pest used as an example of any object (e.g., targeted object). All combinations (including the removal or addition of steps) in this paragraph and the above paragraphs are contemplated in a manner that is consistent with the other portions of the detailed description.

With continued reference to the aforementioned methods, systems, or apparatus, the one or more background elements may comprise one or more gridlines. The one or more background elements may comprise a texture of the pest-control capture apparatus. The one or more foreground elements may comprise a physical object. The one or more foreground elements may comprise a strut. The one or more foreground elements may comprise a condition associated with lighting. The one or more foreground elements may comprise a shadow. The one or more foreground elements may comprise dust. The generating the second image based on the removing of the first background element of the one or more background elements may be further based on whether the color of the background element is similar to a color of the one or more objects in the one or more classes. The one or more background elements may comprise a physical object. The one or more background elements may comprise a strut. The one or more background elements may comprise a condition associated with lighting. The one or more background elements may comprise a shadow. The one or more background elements may comprise dust. The one or more background elements may comprise one or more portions of (e.g., attached with or incorporated into) the pest-control capture apparatus that comprise a similar color to an identified pest. The one or more background elements may comprise one or more portions of the pest-control capture apparatus. The one or more background elements may comprise a fastener of the pest-control capture apparatus. The pest-control capture apparatus may comprise a fly light that includes an adhesive board. The sensor may comprise a camera. The z-index may be associated with a two layer z-index. The z-index may be associated with a full z-index. All combinations (including the removal or addition of steps) in this paragraph and the above paragraphs are contemplated in a manner that is consistent with the other portions of the detailed description.

A system may include an image capture device or other sensors configured to obtain high-resolution images or other data of surfaces containing object sets; an edge processing unit configured to perform initial image preprocessing, background analysis, or preliminary object detection; and a cloud platform configured to perform deep learning inference, multi-class object identification, or generation of count statistics or visualizations. The edge processing unit may be further configured to detect and analyze background patterns or grids present in the image; recognize and exclude grid elements from object detection; and leverage identified grid structures for object localization and measurement. The cloud platform may be configured to utilize a deep learning model to detect multiple object classes simultaneously; bound all detected objects, including those not confidently classified; filter detected objects based on predefined acceptance criteria for each class; and generate (e.g., display) count statistics or visualizations for objects in each accepted class. All combinations (including the removal or addition of steps) in this paragraph and the above paragraphs are contemplated in a manner that is consistent with the other portions of the detailed description.

By systematically removing background and foreground elements that could interfere with object detection, the disclosed subject matter may significantly reduce false positives and may improve detection of partially obscured objects. The use of a spatial (e.g., space) partition model allows the system to maintain accurate spatial relationships and size information even as interfering elements are removed from the image.

What is claimed:

1. A method comprising:
removing a first background element of one or more background elements of a first image;
generating a second image based on the removing of the first background element of the one or more background elements;
detecting one or more objects included in the second image;
generating, based on the second image, a spatial partition model associated with understanding a z-index and at least a partially obscured area while preserving relative sizes of the one or more objects;
determining, based on the spatial partition model, one or more foreground elements associated with the second image that obscures a capture area in the second image;
removing a first foreground element of the one or more foreground elements; and
displaying a third image with the first foreground element of the one or more foreground elements removed.

2. The method of claim 1, further comprising:
detecting one or more objects included in the third image;
filtering the detected one or more objects based on a predefined acceptance criteria associated with one or more classes;
generating count statistics associated with the detected one or more objects in the one or more classes; and
transmitting the count statistics.

3. The method of claim 1, wherein the first image is captured by a sensor.

4. The method of claim 1, wherein the z-index is associated with a two layer z-index.

5. The method of claim 1, wherein the z-index is associated with a full z-index.

6. The method of claim 1, wherein the one or more foreground elements comprise a strut, a condition associated with lighting, or dust.

7. The method of claim 1, wherein the one or more background elements comprise one or more grid lines or a texture of the capture area.

8. The method of claim 1, wherein the generating the second image based on the removing of the first background element of the one or more background elements is further based on whether a color of the first background element is approximately a same color of the one or more objects in the one or more classes.

9. The method of claim 1, wherein the one or more background elements comprises one or more portions attached to the capture area.

10. A device comprising:
a processor; and
a memory coupled with the processor, the memory storing executable instructions that when executed by the processor cause the processor to effectuate operations to:
receive a first image from a sensor, the sensor associated with and in proximity to a capture area;
determine one or more background elements associated with the first image that are associated with the capture area;
remove a first background element of the one or more background elements;
generate a second image based on the removing of the first background element of the one or more background elements;
detect one or more objects included in the second image;
generate, based on the second image, a spatial partition model associated with understanding a z-index and at least a partially obscured area while preserving relative sizes of the one or more objects;
determine, based on the spatial partition model, one or more foreground elements associated with the second image that obscures the capture area in the second image;
remove a first foreground element of the one or more foreground elements;
generate a third image based on the removing of the first foreground element of the one or more foreground elements;
detect one or more objects included in the third image;
filter the detected one or more objects based on a predefined acceptance criteria associated with one or more classes;
generate count statistics associated with the detected one or more objects in the one or more classes; and
transmit the count statistics.

11. The device of claim 10, wherein the capture area comprises a fly light that includes an adhesive board.

12. The device of claim 10, wherein the sensor comprises a camera.

13. The device of claim 10, wherein the z-index is associated with a two layer z-index.

14. The device of claim 10, wherein the z-index is associated with a full z-index.

15. The device of claim 10, wherein the one or more foreground elements comprise a strut, a condition associated with lighting, or dust.

16. The device of claim 10, wherein the one or more background elements comprise one or more grid lines or a texture of the capture area.

17. The device of claim 10, wherein the generating the second image based on the removing of the first background element of the one or more background elements is further based on whether a color of the first background element is approximately a same color of the one or more objects in the one or more classes.

18. The device of claim 10, wherein the one or more background elements comprises one or more portions attached to the capture area.

19. A computer-readable storage medium storing computer executable instructions that when executed by a computing device cause the computing device to effectuate operations comprising:
receive a first image from a sensor, the sensor associated with and in proximity to a capture area;
determine one or more background elements associated with the first image that are associated with the capture area;
remove a first background element of the one or more background elements;
generate a second image based on the removing of the first background element of the one or more background elements;
detect one or more objects included in the second image;
generate, based on the second image, a spatial partition model associated with understanding a z-index and at least a partially obscured area while preserving relative sizes of the one or more objects;
determine, based on the spatial partition model, one or more foreground elements associated with the second image that obscures the capture area in the second image;
remove a first foreground element of the one or more foreground elements; and
display a third image based on the removing of the first foreground element of the one or more foreground elements.

20. The computer-readable storage medium of claim 19, the operations further comprising:
detect one or more objects included in the third image;
filter the detected one or more objects based on a predefined acceptance criteria associated with one or more classes;
generate count statistics associated with the detected one or more objects in the one or more classes; and
transmit the count statistics.
